(19) United States
(12) Patent Application Publication
(10) Pub. No.: US 2019/0024725 A1
(43) Pub. Date: Jan. 24, 2019

(54) CONSTANT VELOCITY JOINT SEAL

(71) Applicant: GM GLOBAL TECHNOLOGY OPERATIONS LLC, Detroit, MI (US)

(72) Inventors: Steven W. Creek, Shelby Township, MI (US); Keith W. Noser, Birmingham, MI (US); Sahar Nasif, Windsor (CA); Soundararajan Vijayanarayanasamy, Shelby Township, MI (US)

(21) Appl. No.: 15/655,300

(22) Filed: Jul. 20, 2017

(51) Int. Cl. F16D 3/84; F16D 3/18

(52) U.S. Cl. CPC F16D 3/845; F16D 3/223; F16D 3/848; F16D 3/18

(57) ABSTRACT

A shaft assembly includes a first shaft, a second shaft and a constant-velocity joint secured to the second shaft. The constant-velocity joint includes an outer can secured to the second shaft and an inner race located at least partially in an outer can pocket. The first shaft is coupled to the inner race. The shaft assembly further includes a seal assembly including an outer boot having an outer boot first end secured to the first shaft and an outer boot second end secured to the outer can.

### INTRODUCTION

The subject disclosure relates to sealing of a driveline of a motor vehicle and, more particularly, to sealing at an interface of a shaft and a constant velocity joint of a motor vehicle.

Motor vehicles utilize drive shafts to transfer rotational energy from, for example, an internal combustion engine or a transfer case output shaft to a differential or other components from distribution of the rotational energy. The drive shaft often includes a constant-velocity joint allowing for the transfer of rotational energy across the joint through a variable angle, at a constant rotational speed, without an appreciable increase in friction or play. To reduce weight and improve balance, many drive shaft connections are migrating to plug-on connections, where a constant-velocity joint inner race fits onto a splined stem of an input shaft or an output shaft to which it is to be connected. While the completed, assembled package saves mass and results in a smaller package due to the elimination of fasteners present in a typical connection, additional clearance is needed at assembly and disassembly to allow for the “plugging-on” of the inner race onto the splined stem. Accordingly, it is desirable to provide a constant-velocity joint interface with increased clearance to neighboring components of the motor vehicle.

### SUMMARY

In one exemplary embodiment, a shaft assembly includes a first shaft, a second shaft and a constant-velocity joint secured to the second shaft. The constant-velocity joint includes an outer can secured to the second shaft and an inner race located at least partially in an outer can pocket. The first shaft is coupled to the inner race. The shaft assembly further includes a seal assembly including an outer boot having an outer boot first end secured to the first shaft and an outer boot second end secured to the outer can.

In addition to one or more of the features described herein, the shaft assembly includes a first shaft spline and an inner race spline engaged with the first shaft spline.

In addition to one or more of the features described herein, the seal assembly further includes an inner boot having an inner boot first end secured to the outer can and an inner boot second end secured to the inner race.

In addition to one or more of the features described herein, the inner boot is configured to seal the outer can to the inner race to prevent leakage of lubricant from a lubricated volume defined by the outer can pocket of the outer can and the inner boot.

In addition to one or more of the features described herein, the inner boot is adhered to the outer can.

In addition to one or more of the features described herein, the outer boot fits over the inner boot at the outer can.

In addition to one or more of the features described herein, the outer boot includes one or more convolutions between the outer boot first end and the outer boot second end.

In addition to one or more of the features described herein, the inner race is positioned in the outer can pocket to allow angular movement of the inner race relative to a can central axis of the outer can.

In addition to one or more of the features described herein, the outer boot is configured prevent entry of contaminants into an interface of the first shaft and the inner race.

In another exemplary embodiment, a vehicle includes a body, a powertrain having an output shaft, a drive shaft, and a constant-velocity joint secured to the drive shaft. The constant-velocity joint includes an outer can secured to the drive shaft and an inner race located at least partially in an outer can pocket. The output shaft is coupled to the inner race. A seal assembly includes an outer boot having an outer boot first end secured to the output shaft, and an outer boot second end secured to the outer can.

In addition to one or more of the features described herein, the vehicle includes an output shaft spline and an inner race spline engaged with the output shaft spline.

In addition to one or more of the features described herein, the seal assembly further includes an inner boot having an inner boot first end secured to the outer can and an inner boot second end secured to the inner race.

In addition to one or more of the features described herein, the inner boot is configured to seal the outer can to the inner race to prevent leakage of lubricant from a lubricated volume defined by the outer can pocket of the outer can and the inner boot.

In addition to one or more of the features described herein, the inner boot is adhered to the outer can.

In addition to one or more of the features described herein, the outer boot fits over the inner boot at the outer can.

In addition to one or more of the features described herein, the outer boot includes one or more convolutions between the outer boot first end and the outer boot second end.

In addition to one or more of the features described herein, the inner race is positioned in the outer can pocket to allow angular movement of the inner race relative to a can central axis of the outer can.

In addition to one or more of the features described herein, the outer boot is configured to prevent entry of contaminants into an interface of the output shaft and the inner race.

In addition to one or more of the features described herein, the output shaft is an output shaft of a transfer case of the vehicle.

In addition to one or more of the features described herein, the drive shaft extends from the constant-velocity joint toward a first axle of the vehicle.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic plan view of an embodiment of a vehicle and a powertrain; and

FIG. 2 is a cross-sectional view of an embodiment of a shaft connection for a vehicle powertrain utilizing a constant-velocity joint.

### DETAILED DESCRIPTION

The following description is merely exemplary in nature and is not intended to limit the present disclosure, its application or uses. It should be understood that throughout the drawings, corresponding reference numerals indicate like or corresponding parts and features.

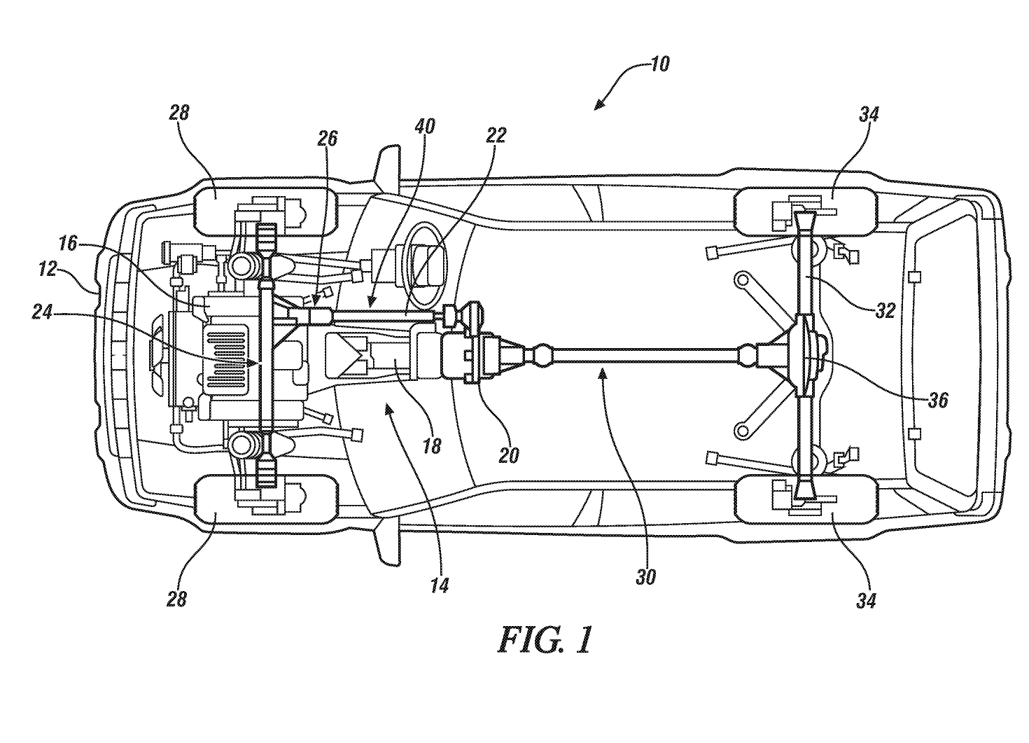

A vehicle 10, in accordance with an exemplary embodiment is schematically illustrated at FIG. 1. The vehicle 10 includes a body 12 supportive of a powertrain 14. The powertrain 14 includes a prime mover 16, for example, an electric motor, a hybrid motor, or an internal combustion motor. In the embodiment of FIG. 1, power is transferred from the prime mover 16, through a transmission 18, and to a transfer case 20. A first axle 24 is connected to one or more first wheels 28, and may be connected to the transfer case via a first drive shaft 22. Similarly, a second axle 32 is connected to one or more second wheels 34 and is connected to the transfer case via a second drive shaft 30.

The second drive shaft 30 is connected to the transfer case 20 to transfer power to the one or more second wheels 34 via the second axle 32, while in some embodiments the first drive shaft 22 transfers power from the transfer case 20 to the first axle 24 to drive the one or more first wheels 28. In some embodiments, the first drive shaft 22 is operably connected to the transfer case 20 via, in some embodiments, a first differential 26 or other arrangement. Similarly, in some embodiments, the second drive shaft 30 is connected to the second axle 32 via a second differential 36. In the embodiment of FIG. 1, a vehicle 10 equipped with a four-wheel drive or all-wheel drive powertrain 14 is illustrated, in which both the first wheels 28 and the second wheels 34 are operably connected to, and driven by, the powertrain 14. One skilled in the art, however, will readily appreciate that the present disclosure may be similarly applied to vehicles having other powertrain arrangements, such as a two-wheel drive powertrain which drives either the first wheels 28 or the second wheels 34.

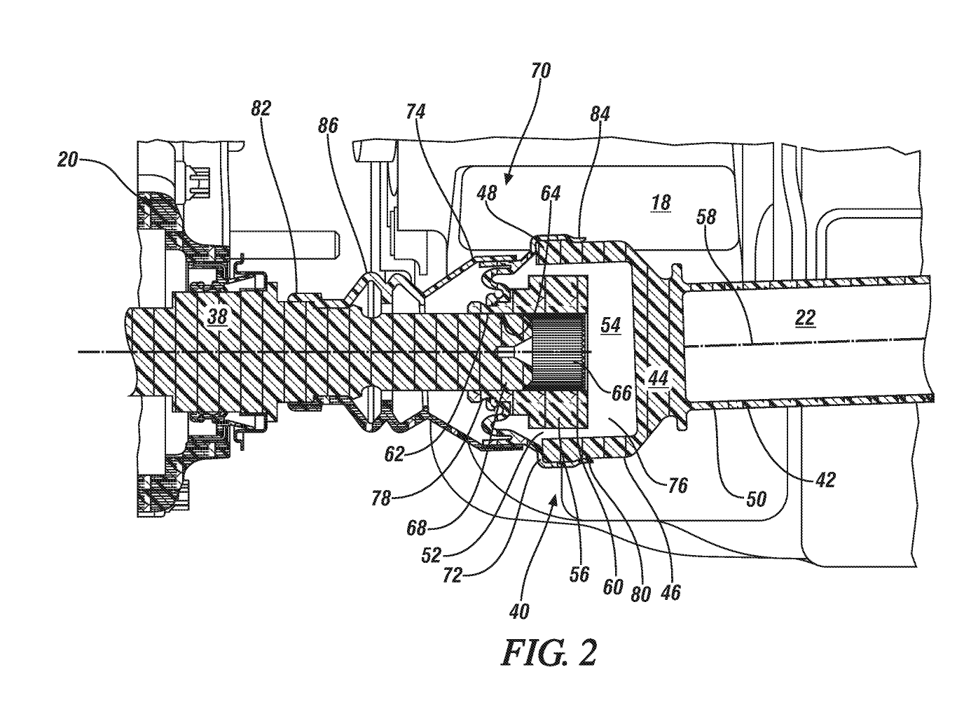

Referring now to FIG. 2, shown is an embodiment of a shaft connection between, in this embodiment, the transfer case 20 and the first drive shaft 22. The transfer case 20 includes an output shaft 38 connected to the first drive shaft 22. The first drive shaft 22 includes a constant-velocity joint 40 at a first shaft end 42 of the first drive shaft 22, for connection to the output shaft 38. The constant velocity joint 40 includes an outer can 44 secured to the first shaft end 42. The outer can 44 includes a can outer surface 46 extending from a first can end 48 to a second can end 50, with the second can end 50 disposed at the first shaft end 42. The first can end 48 has a can opening 52 therein, defining a can pocket 54.

The constant-velocity joint 40 also includes an inner race 56 located in the can pocket 54, and movably positioned in the can pocket 54 to allow angular movement of the inner race 56 relative to a can central axis 58 of the outer can 44. The inner race 56 is, in some embodiments, a tubular member, and has an exterior race surface 60 and an interior race surface 62. The interior race surface 62 defines a race opening 64 into which the output shaft 38 is installed. To engage the output shaft 38 with the inner race 56, the interior race surface 62 includes a race spline 66, and the output shaft 38 includes a complimentary shaft spline 68, which meshes with the race spline 66 when the output shaft 38 is inserted into the race opening 64.

To prevent contaminants from damaging the constant-velocity joint 40 and/or the output shaft 38 to constant velocity joint 40 interface, a joint seal 70 is installed at the output shaft 38 and the constant velocity joint 40. The joint seal 70 includes an inner boot 72 and an outer boot 74. The inner boot 72 is configured to seal the outer can 44 to the inner race 56 to contain constant velocity joint 40 lubricant, for example, grease, thereby preventing leakage of the lubricant from a lubricated volume 76 defined by the can pocket 54 and the inner boot 72. The inner boot 72 includes an inner boot first end 78 secured at the exterior race surface 60 and an inner boot second end 80 secured at the can outer surface 46. In some embodiments, the inner boot 72 may be molded to or otherwise adhered to the outer can 44. Alternatively or additionally, the inner boot 72 may be secured to the outer can 44 and/or the inner race 56 by one or more fasteners or clamps (not shown).

The outer boot 74 is configured to prevent entry of contaminants into the race spline 66 and shaft spline 68 interface. The outer boot 74 includes an outer boot first end 82 secured to the output shaft 38 and an outer boot second end 84 secured to the outer can 44. The outer boot 74 may include one or more convolutions 86 between the outer boot first end 82 and the outer boot second end 84 to absorb the relative motion between the outer can 44 and the output shaft 38. In some embodiments, the outer boot first end 82 and/or the outer boot second end 84 are secured in place by one or more clamps (not shown).

Securing the outer boot second end 84 to the outer can 44, rather than to the inner race as in prior configurations, allows for the inner race 56 to be axially shorter, since axial length of the inner race is needed to secure the boot to the inner race. With an axially shorter inner race 56, the assembly and/or disassembly of the output shaft 38 to the drive shaft 22 via the constant-velocity joint 40 can be more easily accomplished in tight proximity to the transmission 18 or other components.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A shaft assembly, comprising:
a first shaft;
a second shaft;
a constant-velocity joint secured to the second shaft, the constant-velocity joint including:
an outer can secured to the second shaft; and
an inner race disposed at least partially in an outer can pocket, the first shaft coupled to the inner race; and
a seal assembly including an outer boot having:
an outer boot first end secured to the first shaft; and
an outer boot second end secured to the outer can.

2. The shaft assembly of claim 1, further comprising:
a first shaft spline; and
an inner race spline engaged with the first shaft spline.

3. The shaft assembly of claim 1, the seal assembly further comprising an inner boot including:
an inner boot first end secured to the outer can; and
an inner boot second end secured to the inner race.

4. The shaft assembly of claim 3, wherein the inner boot is configured to seal the outer can to the inner race to prevent leakage of lubricant from a lubricated volume defined by the outer can pocket of the outer can and the inner boot.

5. The shaft assembly of claim 3, wherein the inner boot is adhered to the outer can.

6. The shaft assembly of claim 3, wherein the outer boot fits over the inner boot at the outer can.

7. The shaft assembly of claim 1, wherein the outer boot includes one or more convolutions between the outer boot first end and the outer boot second end.

8. The shaft assembly of claim 1, wherein the inner race is positioned in the outer can pocket to allow angular movement of the inner race relative to a can central axis of the outer can.

9. The shaft assembly of claim 1, wherein the outer boot is configured prevent entry of contaminants into an interface of the first shaft and the inner race.

10. A vehicle comprising:
a body;
a powertrain having an output shaft;
a drive shaft; and
a constant-velocity joint secured to the drive shaft, the constant-velocity joint including:
an outer can secured to the drive shaft; and
an inner race disposed at least partially in an outer can pocket, the output shaft coupled to the inner race; and
a seal assembly including an outer boot having:
an outer boot first end secured to the output shaft; and
an outer boot second end secured to the outer can.

11. The vehicle of claim 10, further comprising:
an output shaft spline; and
an inner race spline engaged with the output shaft spline.

12. The vehicle of claim 10, the seal assembly further comprising an inner boot including:
an inner boot first end secured to the outer can; and
an inner boot second end secured to the inner race.

13. The vehicle of claim 12, wherein the inner boot is configured to seal the outer can to the inner race to prevent leakage of lubricant from a lubricated volume defined by the outer can pocket of the outer can and the inner boot.

14. The vehicle of claim 12, wherein the inner boot is adhered to the outer can.

15. The vehicle of claim 12, wherein the outer boot fits over the inner boot at the outer can.

16. The vehicle of claim 10, wherein the outer boot includes one or more convolutions between the outer boot first end and the outer boot second end.

17. The vehicle of claim 10, wherein the inner race is positioned in the outer can pocket to allow angular movement of the inner race relative to a can central axis of the outer can.

18. The vehicle of claim 10, wherein the outer boot is configured to prevent entry of contaminants into an interface of the output shaft and the inner race.

19. The vehicle of claim 10, wherein the output shaft is an output shaft of a transfer case of the vehicle.

20. The vehicle of claim 10, wherein the drive shaft extends from the constant-velocity joint toward a first axle of the vehicle.
